(19) United States
(12) Patent Application Publication
(10) Pub. No.: US 2002/0163597 A1
(43) Pub. Date: Nov. 7, 2002

(54) Digital multi-tile video display system

(76) Inventors: Kevin Kelleher, Lawrenceville, GA (US); Keith J. Doerrer, Gainesville, GA (US)

Correspondence Address: GARDNER GROFF & MEHRMAN, P.C., PAPER MILL VILLAGE, BUILDING 23, 600 VILLAGE TRACE, SUITE 300, MARIETTA, GA, 30067, US

(21) Appl. No.: 09/848,663

(22) Filed: May 3, 2001

(51) Int. Cl. G09G 5/00; H04N 7/01; H04N 11/20

(52) U.S. Cl. 348/707; 348/451

(57) ABSTRACT

A high resolution, multi-tile video display system is described. The universal display system can effectively produce high-resolution images from data received from both analog devices and digital devices such as televisions, personal digital assistants, and computer systems. Generally, the video display system includes a computer system that receives data from several digital data sources. The computer system generates numerous video signals after processing the data. An interface circuit generates display signals after processing the video signals. The display signals correspond to a fractional portion of the high-resolution image. Several displays receive the display signals. After processing the display signals, the displays jointly produce the high-resolution image.

### TECHNICAL FIELD

The present invention relates generally to large screen displays, and more particularly, to a high-resolution multi-tile video display system for producing high-resolution images on a large screen.

### BACKGROUND OF THE INVENTION

From athletic events to New York's Times Square, the popularity of large screen displays continues. In Times Square, companies can introduce new merchandise to shoppers below using a large screen display. In a stadium, large screen displays often depict replays or close up views of the players. This popularity positively impacts technological developments in this area. The advances results in using large screen displays in broadcast television and home projection television.

In broadcast television, the design of the large screen display enables effective viewing from considerable distances. For example, a basketball replay projected on a large screen can enable viewing by fans more than twenty feet away from the screen. Typically, these types of displays project an enlarged image onto a large multi-tiled display. In broadcast television, repeating pixels, or picture elements, from the original image over a larger physical area magnifies the original image and creates the enlarged image. For example, some large screen displays used in broadcast television could be ten feet wide and ten feet long. If the original image included 250 pixels, each of these pixels would be reproduced in a proportional portion of the 100 square feet. Consequently, the resolution of projected images using broadcast television is approximately two pixels per inch. While a resolution of two pixels per inch could be satisfactory for viewing from ten feet away, the low resolution can inhibit effective close-up viewing. Thus, projected images from broadcast television lack the resolution that enables clear viewing from a few feet away.

Besides broadcast television, home projection televisions also use large screen projection. In contrast to broadcast television, the general viewing range of a home projection television is approximately three to five feet. Consequently, home projection televisions typically have resolutions of approximately ten pixels per inch. The substantially larger resolution indicates the targeted viewing range of home projection televisions is smaller than the viewing range of broadcast televisions. However, the human visual system can perceive images with a resolution of one hundred pixels per inch. Consequently, resolutions on the order of ten pixels per inch for large screen projected images do not take advantage of human visual perceptiveness. Even if some systems can produce projected images with resolutions on the order of one hundred pixels per inch, often these systems use nearby computer systems and display analog video signals. Moreover, these analog systems often include video hardware that integrates multiple video signals into a single video signal and splits this integrated video signal to drive multiple projectors.

Despite the development in the area of multi-tile display systems, conventional solutions lack high resolution, do not enable projection from remote sources, often involve considerable manipulation of video signals using video hardware, and are not digital systems. Thus a need still exists for a digital multi-tile video display system that provides high resolution and enables viewing a few feet away.

### SUMMARY OF THE INVENTION

The present invention meets the needs described above in a video display system that produces an expansive high-resolution image. The invented display system includes a computer system that receives data from a plurality of digital data sources. The computer system generates a plurality of video signals in response to processing the data. An interface circuit generates display signals in response to processing the video signals. The display signals correspond to a fractional portion of the high-resolution image. A plurality of displays receives the display signals. After processing the display signals, the displays jointly produce the expansive high-resolution image.

According to one aspect of the invention a video display system for producing an expansive high-resolution image includes a computer system. The computer system receives data from several digital data sources and generates a plurality of video signals in response to processing the data. An interface circuit generates display signals in response to processing the video signals. Each of the display signals corresponds to a fractional portion of the high-resolution image. The video display system also includes a video input device for receiving analog signals from a plurality of analog data sources. A plurality of displays receives the display signals and the analog signals. Together, the displays jointly produce the high-resolution image in response to processing the display signals and the analog signals.

In another aspect, the invention is a digital video display system for producing an expansive high-resolution image. This system includes a computer system for receiving data from a plurality of digital data sources. The computer system generates a plurality of display signals in response to processing the data. Each of the display signals corresponds to a fractional portion of the high-resolution image. A video input device for receiving analog signals from a plurality of analog data sources is also included. A plurality of displays receives the display signals and the analog signals. The displays jointly produce the high-resolution image in response to processing the display signals and the analog signals.

In view of the foregoing, it will be appreciated that a video display system, according to the present invention, avoids the drawbacks of prior systems, while providing an expansive high-resolution image. The specific techniques and structures employed by the invention to improve over the drawbacks of the prior systems and accomplish the advantages described herein will become apparent from the following detailed description of the embodiments of the invention and the appended drawings and claims.

### BRIEF DESCRIPTION OF THE DRAWINGS

FIG. 1A is a functional block diagram of an environment in which a high resolution, multi-tile digital video display system can produce expansive high-resolution images.

FIG. 1B is a perspective view of the video display system of FIG. 1A.

FIG. 2 is a functional block diagram of the video display system shown in FIG. 1 illustrating the receipt of data from various video sources.

FIG. 3 is a quasi-circuit diagram of a first embodiment of the video display system of FIG. 2 illustrating transmission of signals to four displays.

FIG. 4 is a quasi-circuit diagram of a second embodiment of the video display system of FIG. 2 illustrating transmission of signals to nine displays.

FIG. 5 is a Windows based screen illustrating a graphic user interface for the video display system of FIG. 2.

### DETAILED DESCRIPTION OF THE EMBODIMENTS

In describing the embodiments of the present invention, specific terminology is employed for the sake of clarity. The invention, however, is not intended to be limited to the specific terminology so selected.

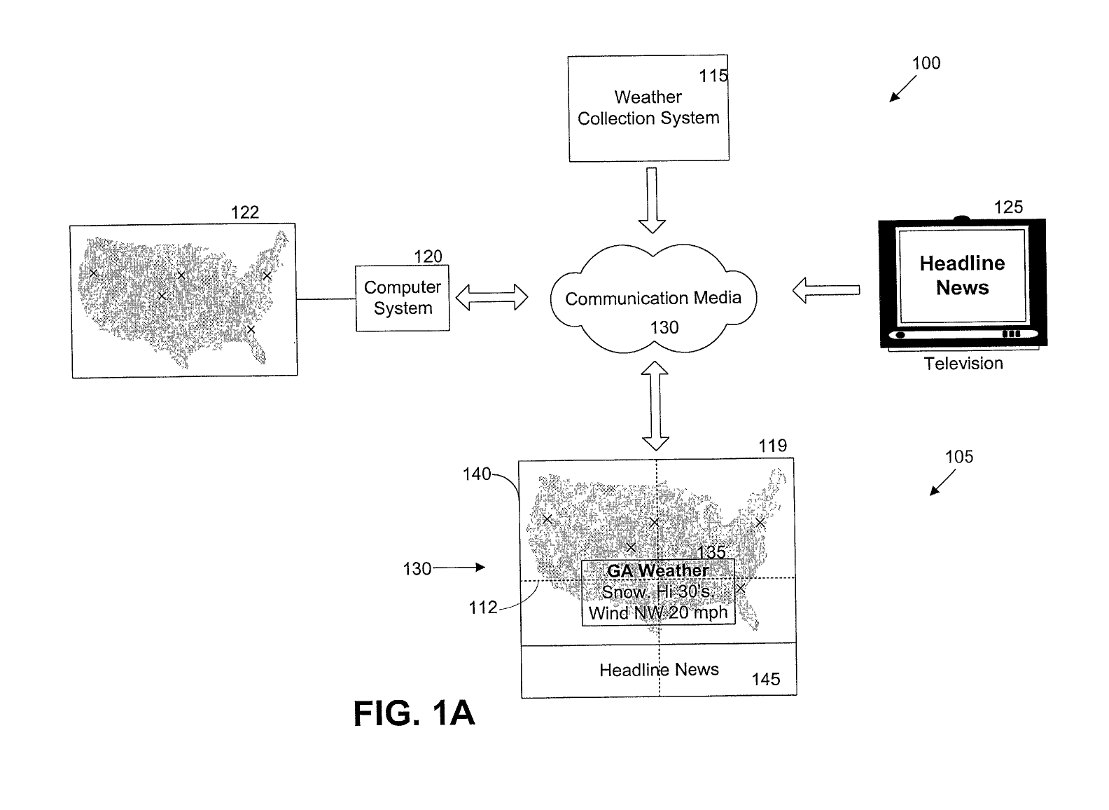

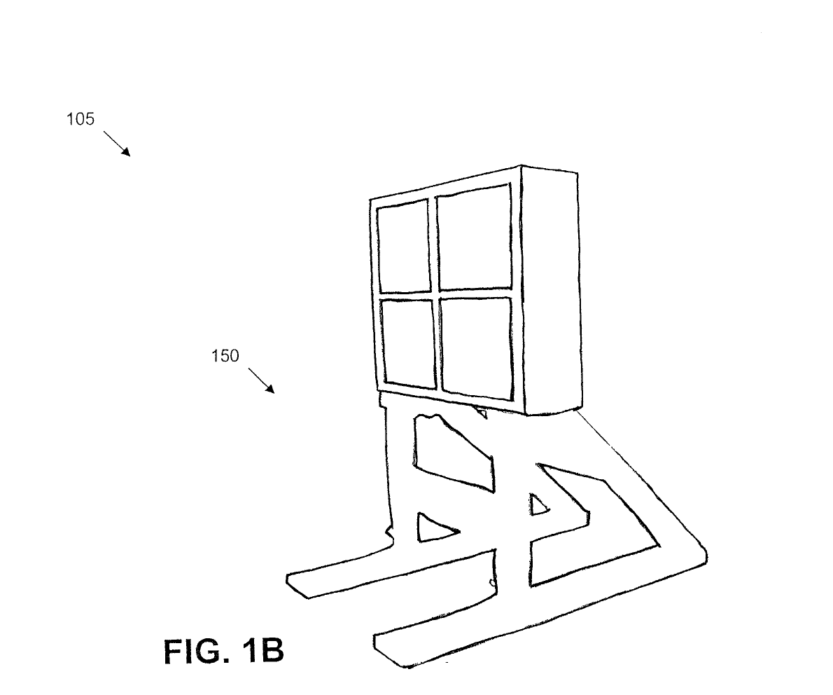

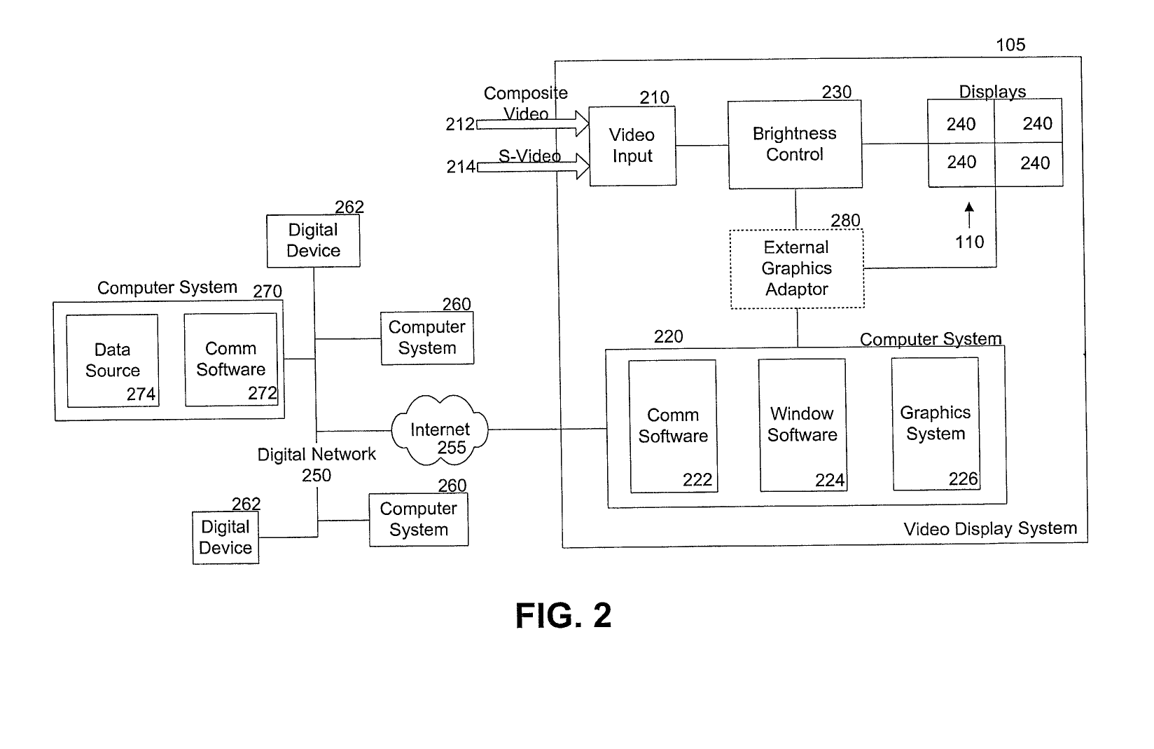

Turning to the figures, FIG. 1A is a functional block diagram of an environment 100 in which a high-resolution multi-tile digital video display system 105 can produce expansive high-resolution images. The display system 105 includes a large screen 110 composed of several flat panel displays as indicated by the dashed lines 112. Though FIG. 1 illustrates four flat panel displays, the number and type of displays can vary as described with reference to FIG. 2. Using the flat panel displays, the video display system 105 can reproduce information collected from a host of data sources.

The environment 100 includes several data sources positioned remotely from the video display system 105, such as a weather collection system 115, computer system 120, and television 125. The weather system 110 acquires weather data and transfers it to the video display system 105 using the communication media 130. If the weather system 110 includes a digital interface, the weather system 110 could connect to a digital network. For example, the weather system 110 can transfer twelve hours of collected weather data for the state of Georgia to the video display system 105 by using the Internet as the communication media 130. In response, the video display system 105 displays a Georgia forecast in a window 135 positioned remotely from the weather system 110. The Georgia forecast could predict snow, a high temperature in the thirties, and a northwesterly wind of twenty miles per hour.

Like the weather collection system 115, the computer system 120 and the television 125 could also transfer data to the video display system 105. Using a display 122, the computer system 120 could illustrate a map of the United States with locations, such as U.S. army bases, shown with a letter “X.” When the computer system 115 transfers data representing the map, the video display system 105 reproduces the map in a window 140. Similarly, the video display system 105 could also receive data for a Headlines news broadcast from the television 125. In response, the video display system 105 reproduces this broadcast in the window 145.

After producing the forecast window 135, map window 140, and news window 145, the video display system 105 allows remote repositioning and resizing by a user without a loss of resolution. For example, a user of the computer system 120 could enlarge the size of the map window 140, while explaining the “ready” status of army bases marked on the map. These expanded map images retain the same clarity as the original image. Consequently, the video display system 105 effectively produces high-resolution images from one or more remote data sources on large multi-tile screen that allows user customization while maintaining an ultra high resolution. FIG. 1B is a perspective view of the video display system 105 and a corresponding collapsible support stand 150.

Turning now to FIG. 2, the video display system 105 includes a video input 210, computer system 220, brightness control 230, and a large screen 110 with displays 240. The video input 210 generally receives analog video signals, while the computer system 220 receives digital video signals. The brightness control 230 receives and regulates both the analog video signals and the digital video signals. The displays 240 show the high resolution image based on received video signals and a brightness control signal.

The large screen 110 includes the flat panel displays 240 arranged in a matrix configuration. Using active matrix liquid crystal displays as the displays 240 can minimize weight and the spacing between panels, while providing the highest resolution of any large screen technology. While the large screen 110 includes four displays, the number of displays could be one, two, sixteen, or some other suitable number. If the large screen 110 includes four 18.1 inch displays, the diagonal viewing area could be 37 inches. The large screen 110 also includes interface cards for each of the flat panel displays 240 that receive a portion of the ultra high resolution image from the video input 210, the computer system 220, or some combination of the video input 210 and computer system 220. A brightness control 230 regulates the brightness of the multiple flat panel displays 242. For example, the brightness control circuit 255 could include an optical feedback circuit that adjusts brightness as the bulbs degrade. Consequently, the brightness control 230 can adjust the brightness of large screen 110 instead of individual displays 240. Within the computer system 220, a user interface allows variation of the brightness of the large screen 110 by a remote user.

To receive analog video signals, the video input 210 includes a composite video input 212 and a super-video (S-video) input 214. Typically, analog video signals include a luminance signal that controls brightness and a chrominance signal that controls the color content. The composite video 212 input receives both the luminance and chrominance signal on a single cable. In contrast, the S-video input 214 receives the luminance signal and chrominance signal on separate cables. Because the video input 210 includes both a composite input 212 and an S-video input 214, the video input 210 accepts video signals from a variety of sources. These sources could include televisions, videocassette recorders, camcorders, digital video devices (DVDs), some game stations, as well as other suitable devices.

To receive digital video signals, the computer system 220 includes communication software 222, windowing software 224, and a graphics system 226. The windowing software 224 can display and control multiple fields of data simultaneously on a single display surface. The windowing software 224 could be an operating system such as Microsoft Windows NT, Apple MacOS, UNIX, or LINUX. Using Microsoft Windows NT can result in having drivers that support multiple video adaptors. Moreover, windowing software 224 enables user modification of the window size and position. The windowing software 224 includes scaling controls that help maintain the desired resolution as the dimensions of the windows varies. In an alternative embodiment, the video display system 105 can scale using hardware or a combination of hardware and software.

By using the communication software 222, the computer system 220 can exchange data between the computer system 220 and devices connected to a digital network 250. In connecting to the digital network 250, the computer system 220 can use some type of communication media such as the Internet 255. In an alternative embodiment, the digital network 250 could be a wide area network, an Ethernet, or a fiber optic network. Devices connected to the digital network 250 can transmit information to the computer system 220. For example, the computer systems 260, digital devices 262, and computer system 270 can exchange information with the computer system 220. The computer system 270 includes communication software 272 and a data source 274. The data source 274 could be a spreadsheet, word processing document, database file, mapping file, or the like. Typically, the communication software 222 functions as the server of the client communication software 272. Hence, using X-Windows as the communication software 272 results in using X-windows or some compatible software as the communication software 222. Other types of communication software could include, Microsoft Netmeeting, Virtual Network Computer Software (VNC), or Hypertext Markup Language (HTML).

Using VNC as the communication software 222 can create substantial advantages. For example, the computer system 220 can transmit screen updates and accept remote keyboard and mouse commands. In addition, VNC's universality enables easy interfacing with other types of software. For example, the computer system 220 could communicate by using VNC with the communication software 272 even if it was MacOS. Because the source code of VNC is publicly available, rewriting this code can enable its use with personal digital assistants. For example, modifying the code can result in replacing the digital device 262 with a Palm Pilot manufactured by 3M. Consequently, the video display system 105 could remotely display the content of the personal digital assistant on the large screen 110.

Though not shown, the computer systems 260 and digital devices 262 could also contain some type of communication software. The communication software resident on the computer systems 260 could differ from the communication software on the digital devices 262 and the communication software 272. For example, the communication software 272 could be Microsoft Netmeeting. In contrast, the communication software on the digital devices 237 could be X-Windows, while the communication software on the computer systems 225 could be VNC. Consequently, the communication software 222 on the computer system 220 could include X-Windows, Microsoft Netmeeting, and the versatile software VNC. Consequently, the computer system 220 could communicate with various data sources regardless of the application running on the client computer system.

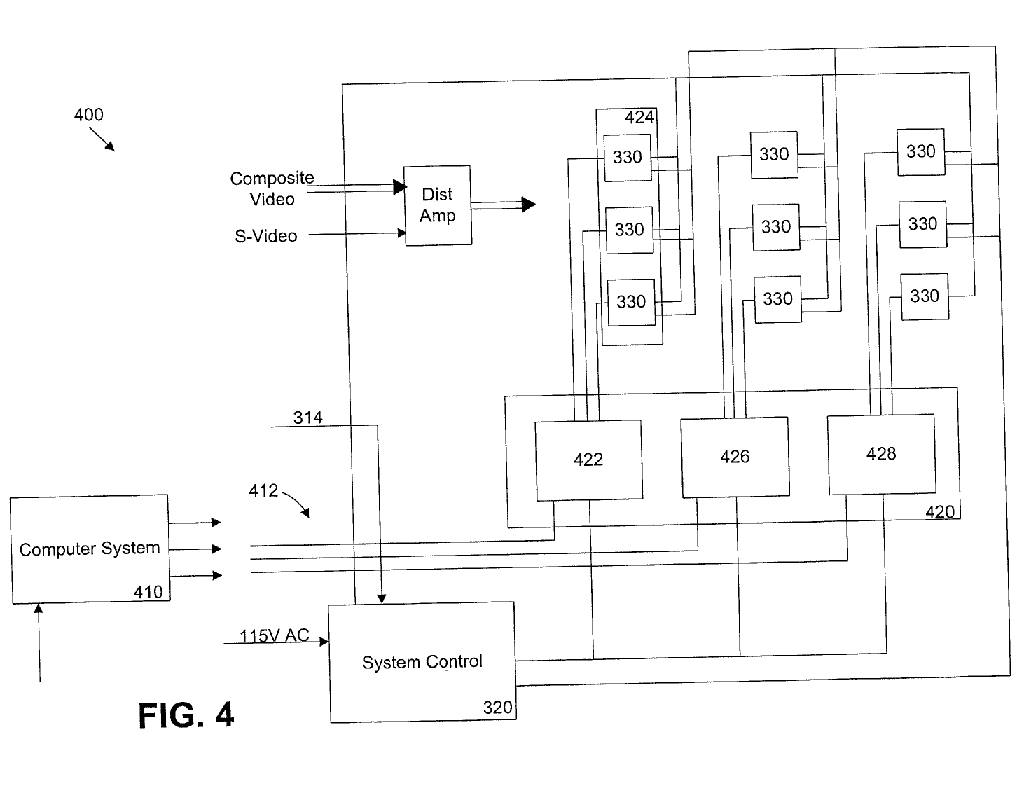

The computer system 220 also includes a graphic system 226 that produces digital video signals for a large number of pixels on the large screen 110. The graphic system 226 could be a Matrox G200 MMMS graphics adaptor that generates ¼ of the high-resolution image for each of the displays 240. In an alternative embodiment, the graphics system 226 could include multiple graphics cards and an external graphics adaptor 280. The graphics adaptor 280 could convert the video signals from the graphics cards into fractional portions of the high-resolution image. As a result, the external graphics adaptor 280 could be a SMARTGLAS hub from Pixel Vision as further described with reference to FIG. 4.

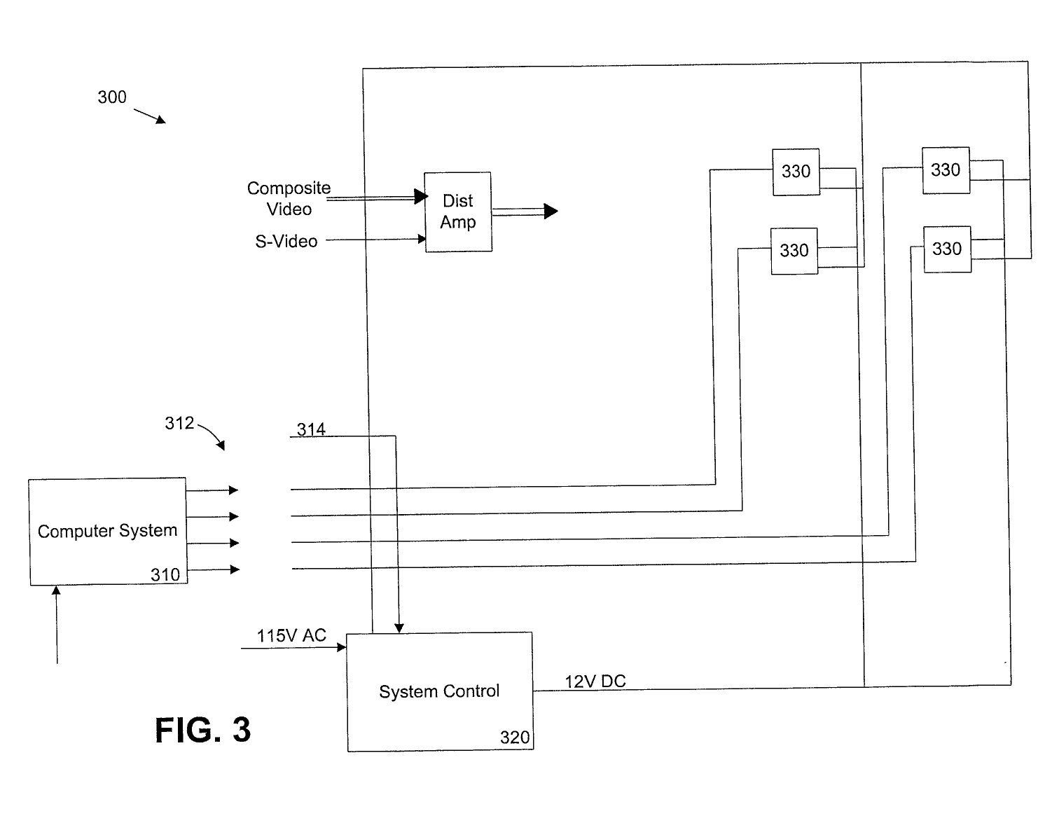

FIG. 3 is a quasi-circuit diagram of a first embodiment of the video display system 105 illustrating a large screen with four flat panel displays. The video display system 300 includes a computer system 310 connected to an Ethernet. Because the computer system 310 includes a Matrox graphics adaptor, the computer system emits four video signals on the video cables 312. In an alternative embodiment with nine displays, the computer system 310 can emit nine video signals. In addition, the computer system emits a brightness control signal along an RS-232 connection 314.

The video display system 300 also includes a system control 320 that converts the 115 volts of alternating current into the 12 volts of direct current needed to power the flat panel displays 330. If the video display system 300 includes heaters, the system control 320 can provide the power needed for the heaters. Finally, the system control 320 disperses the brightness control signals to each of the flat panel displays 330. The video display system 300 also includes a video distributed amplifier that provides the analog video signals to each flat panel display.

FIG. 4 is a quasi-circuit diagram for a second embodiment of the video display system 105 illustrating nine displays and an external graphics system. The video display system 400 includes a computer system 410 and an external graphics system 420. The computer system 410 includes three separate graphics adaptors that jointly produce three video signals along three VGA cables 412. These graphics adaptors could be Matrox G200 Graphics adaptors. An external graphics system 420 receives the video signals, a DC voltage of twelve, and a DC voltage of five. Within the external graphics system 420, the hub 422 transmits video signals for the three displays 424 from the single video signal received on line 423. The signal received on line 423 represents a third of the displayed image. The hub 424 divides this signal and transmits video signals that represent one ninth of the displayed image to the displays 424. The hub 426 and hub 428 function similarly to the hub 424.

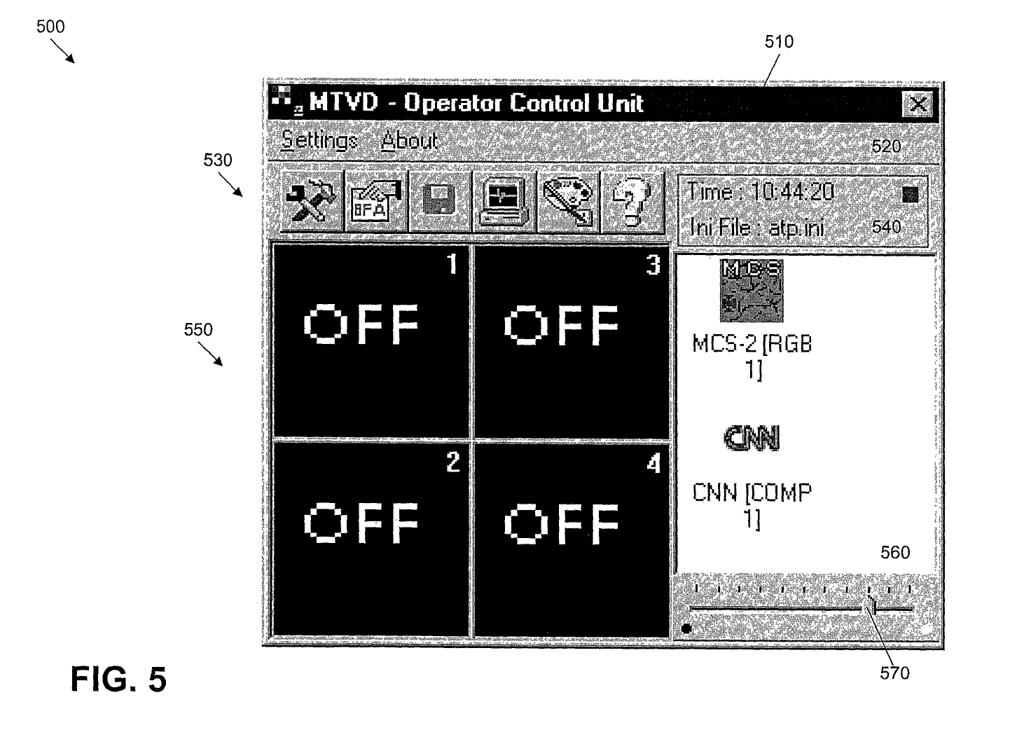

FIG. 5 is a Windows based control screen of a graphic user interface illustrating a control screen 500 for the video display system 105. The screen 500 includes a title bar 510, menu bar 520, a tool bar 530, a status panel 540, a simulated screen 550, an input selection window 560, and a brightness control 570. The title bar 510 resembles a Windows title bar and includes a close window button labeled “X.” The menu bar 520 includes a Settings label and an About label. Selecting the Settings option permits menu access of the software setup features. The tool bar 530 pictorially indicates options available from the Settings menu. The status panel 540 displays the current time of day, the configuration (.ini) file in use, and a visual indication of the video communication status. For example, a red square could indicate that the video display system 105 is not receiving any video communication. The simulated screen 550 includes four simulated AMLCD displays. The input selection window 560 includes user-defined icons. These icons could indicate the configuration file, the video type, and input channel number. Dragging an icon can enable its display on the corresponding tile. Using the brightness slider 570, a user can adjust the backlight brightness on all four tiles in sequence. Though not shown, a similar control screen can be used with a video display system with nine flat panel displays.

In view of the foregoing, it will be appreciated that present invention provides an efficient multi-tile digital video display system that produces high-resolution images from digital video signals and analog video systems. It should be understood that the foregoing relates only to the exemplary embodiments of the present invention, and that numerous changes can be made therein without departing from the spirit and scope of the invention as defined by the following claims.

The invention claimed is:

1. A video display system for producing an expansive high-resolution image, the display system comprising:
a computer system for receiving data from a plurality of digital data sources, the computer system generating a plurality of digital video signals in response to processing the data;
an interface circuit for generating display signals in response to processing the video signals, each of the display signals corresponding to a fractional portion of the high-resolution image; and
a plurality of displays for receiving the display signals, the displays jointly operative for producing the high-resolution image in response to processing the display signals.

2. The display system as in claim 1 further comprising a video input device for receiving analog signals from a plurality of analog data sources.

3. The display system as in claim 1 further comprising a brightness control circuit for uniformly adjusting the brightness of the displays.

4. The display system as in claim 3 wherein the displays are positioned in a rectangular configuration and each of the displays includes a liquid crystal display.

5. The display system as in claim 1 wherein the displays further include a pointer for identifying objects along the displays, the pointer operative to be controlled by at least one of the digital data sources.

6. The display system as in claim 1 further comprising a scaling control device for maintaining a designated resolution as the dimensions of the high-resolution image varies.

7. The display system as in claim 1 wherein the displays change images as the computer system continues generating digital video signals.

8. The display system as in claim 1 wherein the computer system can vary dimensions of the image by using software.

9. The display system as in claim 1 further comprising a network for connecting the digital data sources to the computer system.

10. The display system as in claim 9 wherein the network comprises a fiber optic network.

11. The display system as in claim 9 wherein the network comprises a digital network.

12. A video display system for producing an expansive high-resolution image, the display system comprising:
a computer system for receiving data from a plurality of digital data sources, the computer system generating a plurality of video signals in response to processing the data;
an interface circuit for generating display signals in response to processing the video signals, each of the display signals corresponding to a fractional portion of the high-resolution image;
a video input device for receiving analog signals from a plurality of analog data sources; and
a plurality of displays for receiving the display signals and the analog signals, the displays jointly operative for producing the high-resolution image in response to processing the display signals and the analog signals.

13. The display system as in claim 12 further comprising a brightness control circuit for uniformly adjusting the brightness of the displays.

14. The display system as in claim 12 further comprising a scaling control device for maintaining a designated resolution as the dimensions of the high-resolution image varies.

15. The display system as in claim 12 further comprising a network for connecting the digital data sources to the computer system.

16. The display system as in claim 12 wherein the network comprises a digital network.

17. A digital video display system for producing an expansive high-resolution image, the display system comprising:
a computer system for receiving data from a plurality of digital data sources, the computer system generating a plurality of display signals in response to processing the data, each of the display signals corresponding to a fractional portion of the high-resolution image;
a video input device for receiving analog signals from a plurality of analog data sources; and
a plurality of displays for receiving the display signals and the analog signals, the displays jointly operative for producing the high-resolution image in response to processing the display signals and the analog signals.

18. The display system as in claim 17 wherein the computer system includes a graphics adaptor for generating the display signals in response to processing the video signals.

19. The display system as in claim 17 further comprising a brightness control circuit for uniformly adjusting the brightness of the displays.

20. The display system as in claim 17 further comprising a scaling control device for maintaining a designated resolution as the dimensions of the high-resolution image varies.
